(19) United States
(12) Patent Application Publication
(10) Pub. No.: US 2015/0204267 A1
(43) Pub. Date: Jul. 23, 2015

(54) MODULAR COOLANT CORE-CYLINDER HEAD

(71) Applicants: Ivan M. Lazich, Chicago, IL (US); Tyler R. Vincer, Elmhurst, IL (US); Marton L. Gyuro, West Chicago, IL (US); Steve Peter Gravante, Westchester, IL (US)

(72) Inventors: Ivan M. Lazich, Chicago, IL (US); Tyler R. Vincer, Elmhurst, IL (US); Marton L. Gyuro, West Chicago, IL (US); Steve Peter Gravante, Westchester, IL (US)

(73) Assignee: International Engine Intellectual Property Company, LLC, Lisle, IL (US)

(21) Appl. No.: 14/408,798

(22) PCT Filed: Jun. 26, 2012
(86) PCT No.: PCT/US12/44127

§ 371 Date: Dec. 17, 2014

(51) Int. Cl. F02F 1/40

(52) U.S. Cl. CPC F02F 1/40

(57) ABSTRACT

A modular system for constructing a coolant core/cylinder head structure, is described. The system comprises a modular coolant core having an inlet and an outlet, a plurality of passageways within an interior space of the coolant core, the passageways fluidly connecting, which create a specific coolant flow pattern between the inlet and the outlet, wherein the coolant core has a single pattern geometry for assembling into the cylinder head core box. Use of the individual modular coolant cores permits construction of customized cylinder heads, which use the same tooling across multiple engine platforms, while providing more uniform coolant velocity and heat rejection from cylinder to cylinder and improved structure with more uniform clamping load between head bolts around the combustion chamber.

### TECHNICAL FIELD

The present device relates to a coolant core for a cylinder head in an internal combustion engine. Particularly, the present device relates to a modular coolant core for use in assembling a customized coolant core cylinder head.

### BACKGROUND

The manufacture of cylinder heads for internal combustion engines poses difficult manufacturing problems. The cylinder head of an internal combustion engine, whether for a spark driven gasoline internal combustion engine or a compression ignition diesel engine is a complex article of manufacture with many requirements. A cylinder head generally closes the engine cylinders and contains the many fuel explosions that drive the internal combustion engine, provides separate passageways for the air intake to the cylinders and for the engine exhaust, carries the multiplicity of valves needed to control the air intake and engine exhaust, provides a separate passageway for coolant to remove heat from the cylinder head, and provides separate passageways for fuel injectors and the means to operate the fuel injectors.

The walls forming the complex passageways and cavities of a cylinder head must withstand the extreme internal pressures, temperatures and temperature variations generated by the operation of an internal combustion engine, and must be particularly strong in compression-ignition diesel engines. On the other hand, it is desirable that the internal walls of the cylinder head, particularly those walls between coolant passageways and the cylinder closures, permit the effective transfer of heat from the cylinder head, and it is also important that the cylinder head include minimal metal to reduce its weight and cost.

Some cylinder heads are manufactured by casting them as one piece from iron alloys. The casting of the cylinder head portion that closes the cylinders carries the intake and exhaust valves and fuel injectors and provides the passageways for the air intake, exhaust and coolant requires a mold carrying a plurality of core elements. To provide effective cooling of the cylinder head and effective air intake and exhaust from the cylinder of the internal combustion engine, the passageways for the air intake and exhaust are typically interlaced with the coolant passageways within the cylinder head portion. The cavities for coolant, air intake and exhaust must, of course, be formed by core elements within the mold that can be removed when the casting metal solidifies. Difficulties arise in that a larger core may break during the assembly and casting process.

Countervailing requirements make the manufacture of reliable cylinder head difficult. These complex parts are manufactured by the thousands and assembled into vehicles that must operate reliably under an extreme variety of conditions. Therefore, the manufacture of reliable cylinder heads is particularly important because of the high cost of their replacement. Consequently, the finding efficient and cost-effective ways to manufacture reliable cylinder heads has been the subject of the developmental efforts of engine and automobile manufacturers throughout the world for years.

Currently, generally large, single coolant cores unique to a particular cylinder head are created to cover the specific number of cylinders in that particular head. The present disclosure provides a modular coolant core having a unique geometry, which can be used across multiple engine platforms to create a customized cylinder head. Rather than one water jacket that is only used in a unique cylinder head casting, the modular coolant cores of the present disclosure can be used multiple times depending in a core assembly, essentially customized for the number of cylinders the engine platform using the same core and tooling across many different cylinder head configurations. Because the modular coolant core can be used multiple times, thus replicating the same features and geometry, cooling characteristics such as coolant velocity and heat rejection will be more uniform from cylinder to cylinder. Additionally, because the present modular coolant core is small, it is less prone to cracking during casting and assembly. Thus, the described modular coolant core provides not only ease of use and assembly, by providing a single pattern useful in multiple engines with similar port configurations, but also results in more efficient and consistent cooling performance.

### SUMMARY

There is disclosed herein an improved modular coolant core for a cylinder head for use in an internal combustion engine. The coolant core had a common structural geometry and unique flow pattern, which avoids disadvantages of prior devices, while affording additional structural and operating advantages.

In an embodiment, a modular structure for assembling a cylinder head for an internal combustion engine, is disclosed. The structure comprises a modular coolant core having an inlet and an outlet, a plurality of passageways within an interior space of the coolant core, the passageways fluidly connecting the inlet and the outlet, and wherein the coolant core has a single pattern geometry for assembling into the cylinder head.

In another embodiment, the plurality of passageways creates a unique flow pattern within each coolant core.

In another embodiment, the flow pattern within each coolant core is substantially identical from coolant core to coolant core.

In yet another embodiment, at least one cylinder is associated with each coolant core.

A modular system for constructing a unique coolant core/cylinder head structure for an internal combustion engine, is disclosed. The modular system comprises a lower water jacket, an upper water jacket fluidly connected to the lower water jacket, a plurality of coolant cores forming the lower water jacket, the coolant cores having an inlet for receiving a coolant, and an outlet for releasing the coolant to the upper water jacket, a flow pattern within an interior space of the coolant core fluidly connecting the inlet and the outlet, a cylinder associated with each coolant core, wherein each coolant core has an identical configuration for customized assembly into a modular cylinder head core box having a predetermined configuration and flow pattern from coolant core to coolant core.

These and other aspects of the present device may be understood more readily from the following description of certain embodiments.

### BRIEF DESCRIPTION OF THE DRAWINGS

FIG. 1a-1b illustrate a cylinder head highlighting the lower water jacket of the coolant core;

FIG. 2a-2b illustrate a cylinder hear highlighting the upper water jacket of the coolant core;

FIG. 3 is a perspective view of a modular coolant core of the present disclosure;

FIG. 4 is a perspective view of a partial cylinder head assembly using the modular coolant core of the present disclosure;

FIG. 5 is a perspective view of the modular coolant core of the present disclosure;

FIG. 6 is a cross section of the modular coolant core of FIG. 3;

FIG. 7 is a cast cylinder head with modular coolant cores of the present disclosure; and,

FIG. 8 is a cross section of the modular coolant core showing the structural supporting ribs.

### DETAILED DESCRIPTION

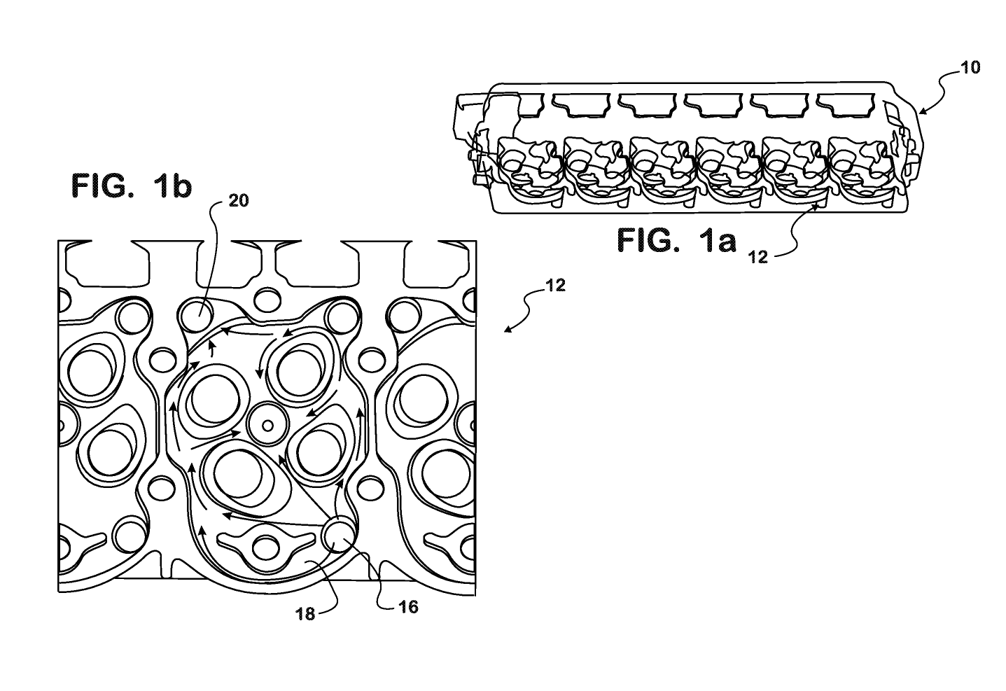

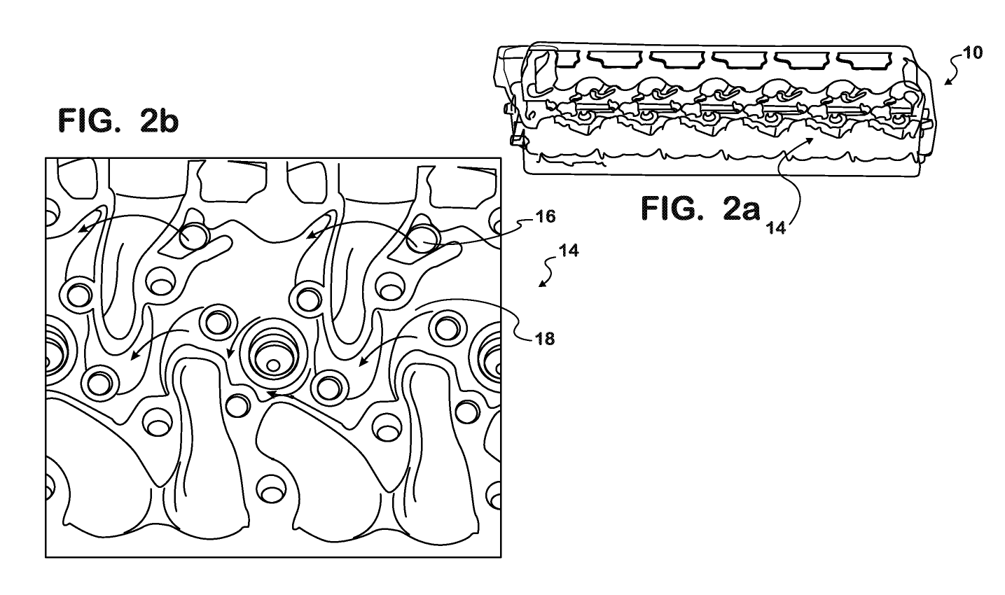

FIGS. 1a-1b and 2a-2b illustrate the core 10 from the modular lower water jacket and the core from the upper water jacket, respectively, in the context of the final cylinder head casting. The coolant core 10 includes the modular lower water or coolant jacket 12 and an upper water or coolant jacket 14. As generally understood, coolant enters the coolant core through a point of entry or inlet 16, in the lower water jacket 12. The coolant flows through a series of passageways 18 within the lower water jacket, through an outlet 22, 24, and into the upper water jacket 14, where it travels through a series of passageways within the upper water jacket. Operation of the cylinder head and coolant core and its association with other engine components is well understood and will not be described in further detail.

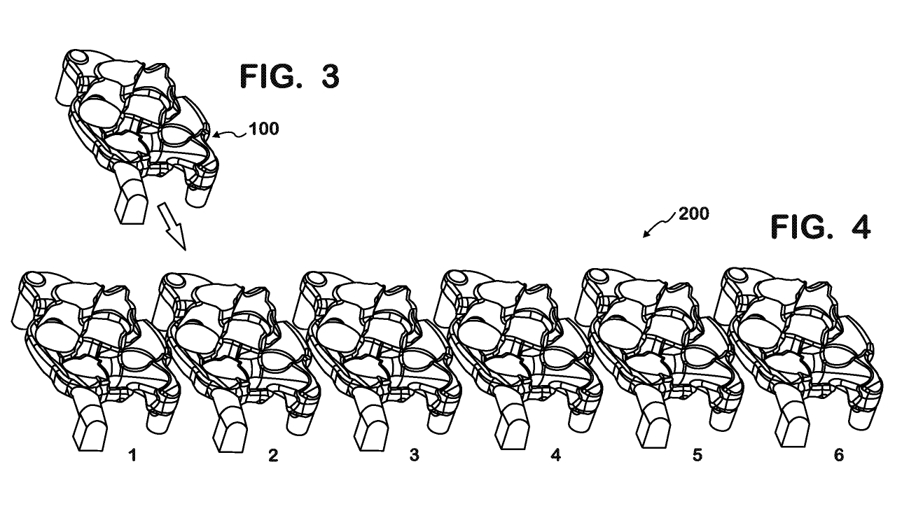

Referring to FIGS. 3-6, there is illustrated a modular coolant core, generally designated 100, which is used in the assembly of a cylinder head core assembly 200. Specifically, the modular coolant core 100 is useful in the construction of the lower water jacket 12 portion. In the present disclosure, a single coolant core 100 unique to a single cylinder is used to essentially create a customized cylinder head for any number of engine platforms, including, but not limited to, an in-line six cylinder, in-line four cylinder or a v8 engine platform. For example, FIG. 4 illustrates a modular coolant core 100 having the same geometry or pattern, being used six times for constructing the cylinder head core assembly of an in-line six cylinder engine. Having the same geometry or pattern of coolant core results in a substantially uniform coolant flow pattern through the cylinder head, which also results in a better, more efficient cooling system. Specifically, cooling characteristics, such as coolant velocity and heat rejection will be more uniform from cylinder to cylinder (regardless of the number of cylinders) due to identical geometry, thus increasing the cooling efficiency.

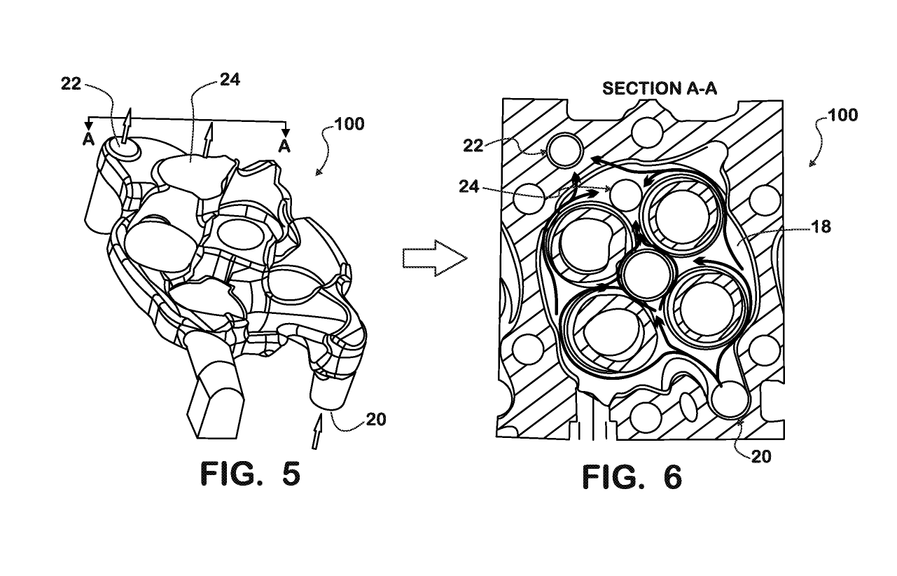

The modular coolant core 100 of the present disclosure is cast using known methods, such as sand casting. The smaller size of the individual coolant cores 100 means that the core is less likely to break during the casting process and assembly of the cylinder head core box. As illustrated in FIG. 5, the modular coolant core 100 has an inlet 20 for receiving coolant from the crankcase (not shown), and an outlet or outlets 22, 24 for releasing the coolant into the upper water jacket 14. It should be understood that the number of inlets and outlets may vary; however, as the geometry of each modular coolant core is substantially the same, the cores used in the construction of a particular cylinder head would all have the same number of inlets and outlets.

FIG. 6 illustrates that when the coolant enters the inlet 20, it travels through a series of passageways 18 within the modular coolant core 100 before exiting into the upper water jacket 14. Each passageway 18 in conjunction with the placement of the inlet 20 and the outlet or outlets 22, 23, results in a unique flow pattern for the coolant within that particular coolant core 100. Optionally, the flow of coolant could be customized. However, while the configuration of the passageways and the unique flow pattern associated with the passageways within the coolant core may vary, each single, individual coolant core 100 would contain the same passageway configuration in order to maintain the uniformity in flow over the cylinders.

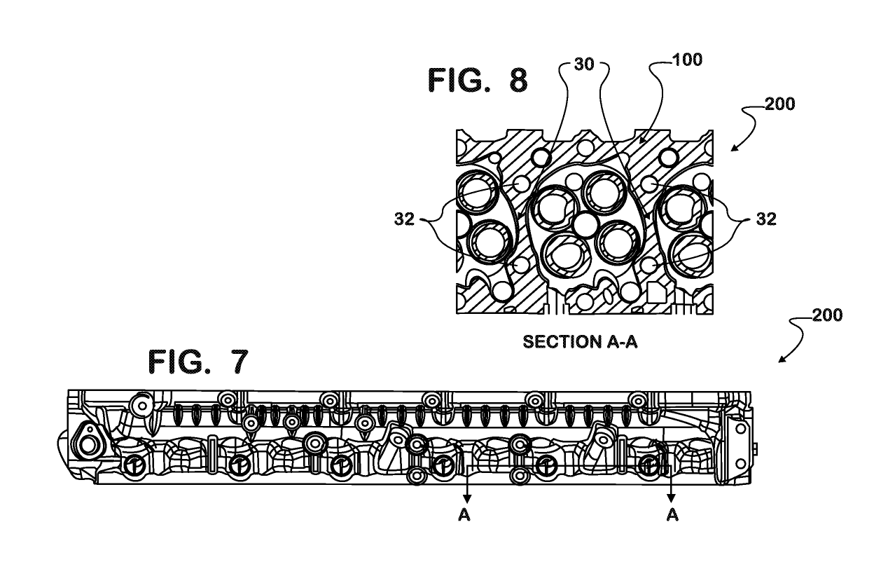

Use of the individual modular coolant cores 100 in the cylinder head assembly, also results in a cylinder head with improved structure. In addition, the overall smaller size of the modular coolant core 100 means that it is less prone to breaking during assembly of the cylinder head core box. As shown in FIGS. 7 and 8, because each modular coolant core 100 is separated, assembly of the cores creates a space or structural rib 30 between each core that would not exist in the traditional single-cast coolant core. Thus, when the cast cylinder head 200 is assembled to the head gasket (not shown) and engine block (not shown), the structural rib 30 provides additional material between the head bolts 32 thereby improving the consistency of the clamping load from the head bolts and the rigidity of the casting around combustion chamber, resulting in a more uniform sealing load along the head gasket, and less stress on the cylinder liners (not shown) (FIG. 8).

The present disclosure provides a modular coolant core useful in the customized assembly of a cylinder head across a variety of engine platforms. In addition, because the modular core has the same geometry and internal configuration, use of the same core results in an improvement in the overall cooling efficiency across all of the cylinders. Use of the smaller core, compared to the traditional large single cast water jacket, means it is less prone to cracking during casting and assembly. Finally, the assembled coolant cores results in a space between each core, which improves the load distribution and uniform sealing along the head gasket. It should be understood that any number of coolant cores may be used in the assembly of the cylinder head, and any variations in geometry of the coolant cores and internal passageways is permitted, depending the specific requirements of a particular engine platform.

What is claimed is:

1. A modular structure for assembling a cylinder head for an internal combustion engine, the structure comprising:
a modular coolant core having an inlet and an outlet;
a plurality of passageways within an interior space of the coolant core, the passageways fluidly connecting the inlet and the outlet,
wherein the coolant core has a single pattern geometry for assembling into the cylinder head.

2. The modular structure of claim 1, wherein the plurality of passageways creates a unique flow pattern within each coolant core.

3. The modular structure of claim 2, wherein the flow pattern is substantial identical within each coolant core.

4. The modular structure of claim 1, wherein each coolant core houses at least one cylinder.

5. The modular structure of claim 4, wherein a number of coolant cores corresponds to a number of cylinders.

6. The modular structure of claim 1, wherein a plurality of individual coolant cores creates a lower water jacket of the cylinder head.

7. The modular structure of claim 1, wherein the structure further comprises a space between the individual coolant cores.

8. The modular structure of claim 7, wherein the space is a structural rib.

9. The modular structure of claim 8, wherein the structural rib is a load distribution rib.

10. A modular system for constructing a coolant core/cylinder head structure for an internal combustion engine, the modular system comprising:
a lower water jacket;
an upper water jacket fluidly connected to the lower water jacket;
a plurality of coolant cores forming the lower water jacket, the coolant cores having an inlet for receiving a coolant, and an outlet for releasing the coolant to the upper water jacket;
a flow pattern within an interior space of the coolant core fluidly connecting the inlet and the outlet;
a cylinder associated with each coolant core;
wherein each coolant core has an identical configuration for customized assembly into a modular cylinder head core box having a predetermined configuration and flow pattern from coolant core to coolant core.

11. The modular system of claim 10, wherein each coolant core includes a substantially similar internal coolant flow pattern fluidly connecting the inlet and the outlet.

12. The modular system of claim 11, wherein the flow pattern comprises a series of substantially identical passageways within each coolant core.

13. The modular system of claim 10, wherein the plurality of coolant cores corresponds with a number of cylinders in the engine.

14. The modular system of claim 10, wherein the structure further includes a load support rib between the individual coolant cores.
